(19) United States
(12) Patent Application Publication
(10) Pub. No.: US 2006/0209027 A1
(43) Pub. Date: Sep. 21, 2006

(54) Optical mouse with a light-interfering unit

(75) Inventor: Chien-Chang Huang, Hsinchu Hsien (TW)

Correspondence Address: The Law Office of Kenneth C. Brooks, P.O. Box 10417, Austin, TX, 78766-1417, US

(73) Assignee: PIXART IMAGING, INC.

(21) Appl. No.: 11/085,638

(22) Filed: Mar. 21, 2005

(51) Int. Cl. G09G 5/08

(52) U.S. Cl. 345/166

(57) ABSTRACT

An optical mouse includes a housing formed with a light-passing hole, alight source, alight-interfering unit and an image sensor. The light source is mounted in the housing for generating a coherent light beam that can pass through the light-passing hole toward a reference surface so as to be reflected by the reference surface. The light-interfering unit is mounted in the housing for effecting interference of the light beam reflected by the reference surface. The image sensor is mounted in the housing for sensing the interfered incident light emerged from the light-interfering unit so as to generate signals that can be used to detect changes in the position of the optical mouse when the optical mouse travels on the reference surface.

### BACKGROUND OF THE INVENTION

1. Field of the Invention

The invention relates to an optical mouse, more particularly to an optical mouse with a light-interfering unit.

2. Description of the Related Art

As shown in FIG. 1, a conventional optical mouse 9 includes a housing formed with a light-passing hole 91, an optical adjusting device 92 for altering the traveling direction of an incident light 81, an image sensor 93 and a processing unit 94. The light-passing hole 91 is adapted for entrance of a first incident light 81 of a surface image 8 at a lateral side of the optical mouse 9. The first incident light 8 passes through the light-passing hole 91 when the optical mouse 9 moves.

The optical adjusting device 92 is an optical lens set that is configured with at least one lens 921, and that is disposed at a predetermined distance from the light-passing hole 91 such that when the first incident light 81 passes through the light-passing hole 91, the first incident light 81 is able to pass through the optical adjusting device 92. When the first incident light 81 passes through the optical adjusting device 92, the lenses 921 of the optical adjusting device 92 are able to alter the direction and light intensity per unit area of the first incident light 81 so as to form a second incident light 82.

The image sensor 93 is mounted at a predetermined distance from the optical adjusting device 92, and positioned such that the second incident light 82 registers with the image sensor 93. The image sensor 93 is coupled electrically with the processing unit 94 to transmit photoelectric signals corresponding to the second incident light 82 to the processing unit 94.

The processing unit 94 is used to convert the photoelectrical signals into electrical signals. Following conversion, the processing unit 94 transmits the electrical signals to a processor of a personal computer for calculation so as to display the movement of a cursor on a screen.

Though the optical mouse 9 is able to convert its movement into electrical signals, which are subsequently calculated by a processor so as to vary the position of the cursor on the screen, the optical mouse 9 nevertheless is not without drawbacks. Namely, a very high precision in manufacturing the lenses 921 of the optical adjusting device 92 with large curvatures and a relatively small thickness is required. Further, the optical adjusting device 92 must undergo sophisticated adjustment and assembly so as to accurately alter the direction and light intensity of the incident light and to focus the incident light on the image sensor 93. As such, the manufacturing cost of the optical adjusting device 92 is very high, thereby making it difficult to reduce the total cost of the optical mouse 9.

Another type of a conventional optical mouse uses pinhole photographic techniques. The optical mouse is able to form an image, which can be recognized using physical characteristics of wave theory, through a round hole with a very small diameter. As a consequence, the optical lens set of the aforesaid conventional optical mouse can be dispensed with. Nevertheless, since the pinhole is relatively small, an insufficient amount of the incident light passes through the pinhole. This poses difficulties for a sensor of the optical mouse in recognizing the image. Therefore, there is still room for improvement.

### SUMMARY OF THE INVENTION

Therefore, the main object of the present invention is to provide an optical mouse that can overcome the aforesaid drawbacks associated with the prior art.

Accordingly, an optical mouse of this invention comprises a housing formed with a light-passing hole, a light source, a light-interfering unit and an image sensor.

The light source is mounted in the housing for generating a coherent light beam which can pass through the light-passing hole toward a reference surface so as to be reflected by the reference surface.

The light-interfering unit is mounted in the housing for effecting interference of the light beam reflected by the reference surface.

The image sensor is mounted in the housing for sensing the interfered incident light emerged from the light-interfering unit so as to generate signals that can be used to detect changes in the position of the optical mouse when the optical mouse travels on the reference surface.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional optic mouse;

FIG. 2 is a schematic diagram of the first preferred embodiment of an optical mouse according to the present invention, wherein the optical mouse has a light-interfering unit formed with an aperture;

FIG. 3 is a schematic diagram of the second preferred embodiment of an optical mouse according to the present invention, wherein the optical mouse has a light-interfering unit formed with a pair of apertures;

FIG. 4 is a schematic diagram of a image sensor of the second preferred embodiment, wherein images to be sensed are formed on light-sensing cells of the image sensor; and

FIG. 5 is a schematic diagram of the third preferred embodiment of an optical mouse according to the present invention, wherein the optical mouse has a light-interfering unit formed with a plurality of apertures which are equidistantly spaced apart.

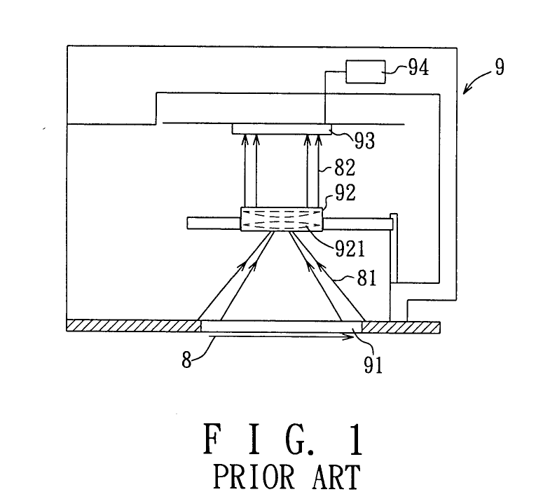

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

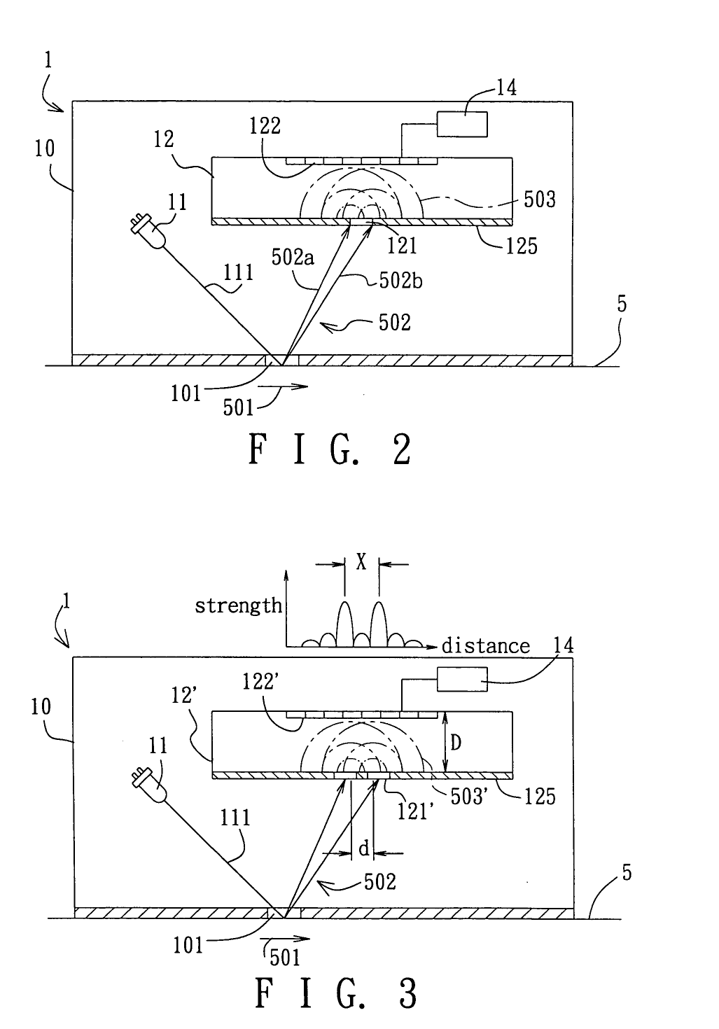

Referring to FIG. 2, the first preferred embodiment of an optical mouse 1 according to the present invention is shown to include a housing 10 formed with a light-passing hole 101, a light source 11, a light-interfering unit 12, an image sensor 122 and a processing unit 14.

The light source 11 is mounted in the housing 10 for generating a coherent light beam 111 which can pass through the light-passing hole 101 toward a reference surface 5 so as to generate a surface image 501 that has an incident light 502 to be reflected by the reference surface 5. It should be noted here that the light source 11 must be able to generate light beams 111 of the same wavelength as a necessary condition for generating an interference effect.

The light-interfering unit 12 is mounted in the housing 10, and includes a light-interfering plate 125 that is disposed between the light-passing hole 101 in the housing 10 and the image sensor 122, and that is formed with an aperture 121 for effecting interference of the incident light 502 reflected by the reference surface 5. When passing through the aperture 121 in the light-interfering plate 125, interference of the incident light 502 occurs to form into an interfered incident light 503.

The image sensor 122 is mounted in the housing 10, and includes image sensing cells 120 facing the light-interfering unit 12 for sensing the interfered incident light 503 emerged from the light-interfering unit 12 so as to generate a detected image (not shown).

The processing unit 14 is mounted in the housing 10, and is coupled to the image sensor 122 so as to generate electrical signals from the detected images generated by the image sensor 122 and so as to detect changes in the position of the optical mouse 1 and display corresponding movement of a cursor on a display device (not shown).

In operation, when the optical mouse 1 travels on the reference surface 5, the light beam 111, which is generated by the light source 11 and which projects onto the reference surface 5, is reflected by the reference surface 5, thereby forming reflected light beams, such as 502a and 502b (see FIG. 2), having different propagating routes from the reference surface 5 to the aperture 121 in the light-interfering plate 125. This difference in propagating routes of the reflected light beams 502a, 502b may be referred as a path difference between the light beams 502a, 502b. Moreover, since both the reflected light beams 502a, 502b are the same in wavelength (λ), where λ is defined as the wavelength of the incident light 502 generated by reflection of the light beam 111 emitted from the light source 11, and are in close proximity to each other while propagating in a similar direction toward the aperture 121, when the path difference between the reflected light beams 502a, 502b is an integer number of the wavelength (n λ), the interfered incident light 503 can be generated with a maximum interference intensity. The aperture 121 in the light-interfering plate 125 has a diameter smaller than the wavelength (λ) of the light beam 111 generated by the light source 11, and preferably ranges from λ/5 to λ/10. Image patterns resulting from the interfered incident light 503 are formed on the image sensor 122 so as to permit determination of movement of the optical mouse 1. Since the size of the aperture 121 is relatively small, the aperture 121 can prevent undesired diffused light from passing therethrough.

As shown in FIG. 3, the second preferred embodiment of an optical mouse 1 according to the present invention differs from the first preferred embodiment in that the light-interfering unit 12′ includes a light-interfering plate 125 that is disposed between the light-passing hole 101 in the housing 10 and the image sensor 122′, and that is formed with two apertures 121′, each of which has a diameter smaller than the wavelength (λ) of the incident light 502 generated by reflection of the light beam 111 formed by the light source 11. When the incident light 502 passes through the apertures 121′, the interference pattern generated by the two apertures 121′ is shown to have two-slit type interference fringes. The apertures 121′ are spaced apart from each other by a first distance which is represented as d, and are spaced apart from the image sensor 122′ by a second distance which is represented as D, so that the interfered incident light 503′ emerging from the light-interfering unit 12 exhibits an interference band width L that is equal to λ (D/d).

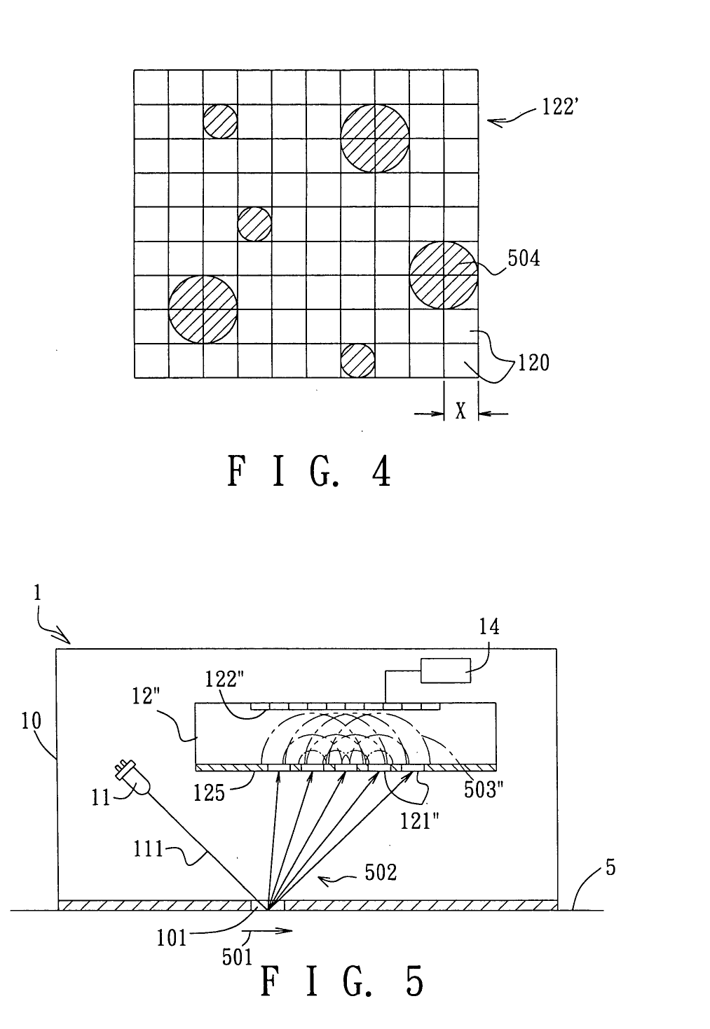

In design, the interference band width L must equal to a unit length X (see FIG. 4) of each of the sensing cells 120 of the image sensor 122′ so as to be effectively detected by the sensing cells 120. Therefore, by adjustment of the magnitudes of D and d, the interfered incident light 503′ is able to be sensed by the sensing cells 120 of the image sensor 122′. The image pattern 504, shown in FIG. 4, on the cells 120 of the image sensor 122′ is the result of the interfered incident light 503′.

As shown in FIG. 5, the third preferred embodiment of an optical mouse 1 according to the present invention differs from the first preferred embodiment in that the light-interfering unit 12″ includes a light-interfering plate 125 that is disposed between the light-passing hole 101 in the housing 10 and the image sensor 122″ and that is formed with a plurality of apertures 121″ each of which has a diameter smaller than the wavelength of the incident light 502 generated by reflection of the light beam 111 emitted from the light source 11. The apertures 121″ are equidistantly spaced apart. When the incident light 502 passes through the light-interfering unit 12″, a plurality of sets of interfered incident light 503″ are formed, which results in the formation of a plurality of sets of image patterns (not shown) on the cells 120 of the image sensor 122″. This multiplicity of image patterns yields a better detection of variations in the position of the optical mouse 1.

In sum, by applying interference techniques, this invention dispenses with expensive optical lens sets as required in the prior art, overcomes the problem of insufficient illuminance as encountered in the prior art, and ultimately realizes a significantly reduction in cost.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An optical mouse comprising:
a housing formed with a light-passing hole;
a light source mounted in said housing for generating a coherent light beam which can pass through said light-passing hole toward a reference surface so as to be reflected by the reference surface to thereby form an incident light;
a light-interfering unit mounted in said housing for effecting interference of the incident light reflected by the reference surface; and
an image sensor mounted in said housing for sensing the interfered light beam emerged from said light-interfering unit so as to generate signals that can be used to detect variations in the position of said optical mouse when said optical mouse travels on the reference surface.

2. The optical mouse as claimed in claim 1, wherein said light-interfering unit includes a light-interfering plate that is disposed between said light-passing hole in said housing and said image sensor, and that is formed with an aperture which has a diameter smaller than the wavelength of the incident light generated by reflection of the light beam emitted from said light source.

3. The optical mouse as claimed in claim 2, wherein the diameter of said aperture in said light-interfering plate is a value ranging from λ/5 to λ/10, in which λ is defined as the wavelength of the light beam generated by said light source.

4. The optical mouse as claimed in claim 1, further comprising a processing unit that is mounted in said housing and that is coupled to said image sensor so as to receive the signals generated by said image sensor and so as to calculate changes in the position of said optical mouse.

5. The optical mouse as claimed in claim 1, wherein said light-interfering unit includes a light-interfering plate that is disposed between said light-passing hole in said housing and said image sensor, and that is formed with two apertures, each of which has a diameter smaller than the wavelength of the light beam generated by said light source, said apertures being spaced apart from each other by a first distance which is represented as d, and being spaced apart from said image sensor by a second distance which is represented as D, so that the interfered incident light emerged from said light-interfering unit exhibits an interference band width that is equal to λ (D/d), in which λ is defined as the wavelength of the light beam generated by said light source.

6. The optical mouse as claimed in claim 1, wherein said light-interfering unit includes a light-interfering plate that is disposed between said light-passing hole in said housing and said image sensor, and that is formed with a plurality of apertures, each of which has a diameter smaller than the wavelength of the light beam generated by said light source, said apertures being equidistantly spaced apart.
